(19) United States
(12) Patent Application Publication
(10) Pub. No.: US 2023/0048320 A1
(43) Pub. Date: Feb. 16, 2023

(54) MAST HEIGHT ROTARY ENCODER

(71) Applicant: Toyota Material Handling, Inc., Columbus, IN (US)

(72) Inventors: Alexander Schlink, Indianapolis, IN (US); Brian Simpson, Columbus, IN (US)

(21) Appl. No.: 17/886,176

(22) Filed: Aug. 11, 2022

Related U.S. Application Data
(60) Provisional application No. 63/232,364, filed on Aug. 12, 2021.

(51) Int. Cl. B66F 9/075; B66F 9/22; B66F 9/08

(52) U.S. Cl. CPC B66F 9/0755; B66F 9/22; B66F 9/07527; B66F 9/08

(57) ABSTRACT

The present disclosure relates to a rotary encoder utilized in cooperation with existing rotary motion of a vehicle mast configured to raise and lower relative to the ground. In particular, an exemplary embodiment of the present disclosure relates to a rotary encoder integrated within a mounting boss of a sheave of a lifting tether pulley to ascertain and communicate mast height to a user and a safety system of the associated vehicle.

### BACKGROUND OF THE DISCLOSURE

### 1. Field of the Disclosure

The present invention relates generally to a system and method for ascertaining the position of a fork of a forklift using a rotary encoder.

### 2. Description of the Related Art

Precise, accurate, and safely communicated feedback, including positioning feedback, is important for all moving mechanical systems of a vehicle, including their carriers (e.g., a fork of a forklift). In an autonomous forklift, for example, the positional feedback for a height of a fork, for example, is integral to the safety and functional capabilities of the vehicle. This feedback is important for both the navigation and control of the forklift, as well as the separately and simultaneously functioning safety system. Other forklifts may also use such positional feedback for data collection or driver assist tools.

In conventional systems, information may be collected by analyzing relative motion between mast stages. For example, one conventional solution may measure the relative position of a stationary outer mast and the carrier using sensors mounted external to and on these separate components, which may leave sensor components exposed due to necessary sensor placement. Additionally, the safety systems require redundant positional feedback, requiring at least two sensors per component. A third sensor per component may further be needed to provide the positional feedback where necessary or used. A simpler, less cost prohibitive solution is desired.

### SUMMARY OF THE DISCLOSURE

The present disclosure relates to a rotary encoder utilized in cooperation with existing rotary components of a vehicle mast configured to raise and lower relative to the ground. In particular, an exemplary embodiment of the present disclosure relates to a rotary encoder integrated within a mounting boss of a sheave of a lifting tether pulley to ascertain and communicate mast height to a user and a safety system of the associated vehicle. The sensor of the present disclosure is integrated into the actuator of the carrier of a lift truck such that no sensor components are located external to the lift mechanism.

In a first aspect of the present disclosure, a forklift is disclosed, the forklift comprising a carrier having a variable lift height; an actuator operable to lift the carrier; and a sensor integrated into the actuator and operable to provide a signal indicative of a position of the carrier along the carrier lift height.

In a second aspect of the present disclosure, a rotary encoder for measuring a lift height of a vehicle is disclosed, the rotary encoder comprising a mounting boss comprising an arm defining a bore; a sheave mounted on the arm of the mounting boss and configured to rotate about the arm; a circuit board assembly positioned within the bore of the mounting boss, the circuit board comprising a magnetic sensor; and a cover coupled to the sheave and configured to rotate with the sheave, wherein a back face of the cover defines a magnet holder containing a magnet so that the magnet rotates upon actuation of the sheave.

In a third aspect of the present disclosure, a system for measuring a lift height of a vehicle is disclosed. The system comprises a rotary encoder. The rotary encoder comprises a mounting boss comprising an arm defining a bore; a sheave mounted on the arm of the mounting boss and configured to rotate about the arm; a circuit board assembly positioned within the bore of the mounting boss, the circuit board comprising a magnetic sensor; and a cover coupled to the sheave and configured to rotate with the sheave, wherein the cover defines a magnet holder containing a magnet so that the magnet rotates upon actuation of the sheave. The circuit board assembly is configured to measure the lift height of the vehicle using the magnetic sensor in relation to rotation of the magnet. The system also comprises a safety system of the vehicle in communication with the circuit board assembly and a vehicle computer. The circuit board assembly is configured to simultaneously transmit lift height information to the safety system of the vehicle and the vehicle computer.

In a fourth aspect of the present disclosure, a method of measuring a lift height of a vehicle is disclosed. The method comprises rotating a rotatable component of a lift system of the vehicle, the rotatable component comprising a magnet pocket containing a magnet; reading and processing an angular change of the magnet with a magnetic sensor; transmitting a first angular change signal to a microcontroller; storing information processed from the first angular change signal in a memory; and transmitting a second angular change signal to a safety system of the vehicle, wherein the first angular change signal and the second angular change signal are transmitted simultaneously.

In a fifth aspect of the present disclosure, a method of measuring a lift height of a vehicle is disclosed, the method comprising rotating a rotatable component containing a readable component; reading an angular change of the readable component with a sensor; transmitting a first signal to a microcontroller; and transmitting a second signal to a safety system, wherein the first signal and the second signal are transmitted simultaneously.

In various aspects of the disclosure, the actuator may comprise a linear actuator; a tether secured to a first component and a second component; and a pulley rotatably supported on the linear actuator, the tether positioned over the pulley intermediate the first component and the second component, whereby actuation of the linear actuator actuates the tether and rotates the pulley. The linear actuator may comprise a hydraulic cylinder and a hydraulic piston, the tether secured to the piston. The pulley may comprise a sheave, the tether positioned in the sheave whereby actuation of the tether by the linear actuator rotates the sheave, and wherein the sensor comprises a magnet secured for rotation with the sheave. The actuator may further comprise a mounting boss, the sheave of the pulley rotatably supported on the mounting boss, wherein the sensor further comprises a magnetic sensor housed by the mounting boss and positioned to sense the angular position of the magnet. The tether may be a lift chain. The first component may be the carrier and the second component may be an inner mast. The first component may be an inner mast and the second component may be an outer mast.

In various aspects of the disclosure, the mounting boss may further comprise a through hole extending beyond the bore into the mounting boss to carry wiring between the circuit board assembly and an electrical system of the vehicle.

In various aspects of the disclosure, the cover may be attached directly to a seal coupled to the sheave and configured to rotate with the sheave. The sheave may be a ball bearing and the seal may cover a plurality of balls.

In various aspects of the disclosure, the rotary encoder may further comprise a retaining ring having a spacer at least partially received within the bore of the mounting boss so that an edge of the spacer is adjacent to the circuit board assembly and a flange of the retaining ring is coupled to an end face of the arm of the mounting boss. The cover may define a trough surrounding the magnet holder so that at least a portion of the flange of the retaining ring is received within the trough and at least a portion of the magnet holder is received within the bore.

In various aspects of the disclosure, the circuit board assembly may be comprised of a wire guide, an insulator, and a circuit board. The wire guide may be comprised of a flexible material. The wire guide may comprise a backboard defining a through hole configured to receive wiring, positioning ledges arranged on two opposing edges of the backboard, and a stage extending laterally from each of the positioning ledges. The insulator may be received between the positioning ledges of the wire guide so that a base of the insulator is adjacent to a top surface of each stage and a gap is defined between the base of the insulator and the backboard of the wire guide. The circuit board may comprise castellated edges for receiving a plurality of pins of the insulator.

In various aspects of the disclosure, the magnetic sensor may include two measurement dies, each of the measure dies configured to output a first signal to a microcontroller of the circuit board assembly and a second signal to the safety system of the vehicle simultaneously. The first signal may be one of a serial peripheral interface signal or a pulse-width modulation signal. The second signal may be a quadrature signal. The circuit board assembly may further include a signal converter configured to receive an absolute quadrature signal from the magnetic sensor, convert the absolute quadrature signal to a differential quadrature signal, and transmit the differential quadrature signal to the safety system of the vehicle.

In various aspects of the disclosure, the lift height information may be stored in a non-volatile memory.

In various aspects of the disclosure, the vehicle computer and the circuit board assembly may be communicatively coupled with two-way communication.

In various aspects of the disclosure, the method may further comprise transmitting the information processed from the first angular change signal to a vehicle computer.

In various aspects of the disclosure, the method may further comprise identifying a safety concern and placing the vehicle in a fault state.

In various aspects of the disclosure, the step of transmitting a second angular change signal may comprise transmitting an absolute quadrature signal to a signal converter; converting the absolute quadrature signal to a differential quadrature signal; and transmitting the differential quadrature signal to the safety system.

In various aspects of the disclosure, the memory may be a non-volatile memory.

In various aspects of the disclosure, the method may further comprise storing the first signal in a memory.

In various aspects of the disclosure, the method may further comprise transmitting the first signal to a vehicle computer. The vehicle computer and the microcontroller may be configured for two-way communication.

In various aspects of the disclosure, the readable component may be a magnet.

The sensor may be a magnetic sensor.

In various aspects of the disclosure, the readable component may be an optically read pattern. The sensor may be an optical rotary sensor.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1A is a perspective view of an exemplification of a vehicle having a three stage mast lift in a fully lifted state;

FIG. 1B is a rear view of the mast lift of the vehicle of FIG. 1A;

FIG. 2A is a perspective view of an exemplary pulley mounting boss of an exemplary front cylinder of an exemplary mast lift;

FIG. 2B is a perspective view of an exemplary pulley mounting boss of an exemplary middle mast of the exemplary mast lift;

FIG. 2C is a cross-sectional view of the pulley mounting boss of FIG. 2A taken along line C-C;

FIG. 3A is a perspective view of a circuit board assembly of a rotary encoder for use with an exemplary mast lift;

FIG. 3B is an exploded view of the circuit board assembly of FIG. 3A;

FIG. 4 is a front perspective partially exploded view of a rotary encoder for use with an exemplary mast lift, including the circuit board assembly of FIG. 3A;

FIG. 5 is a rear perspective partially exploded view of the rotary encoder of FIG. 4;

FIG. 6 is a partial cross-section of the assembled rotary encoder of FIG. 4;

FIG. 7 is a schematic of a system for utilizing the rotary encoder of FIG. 4, including a schematic illustration of a circuit board and corresponding components; and

FIG. 8 is a flow chart illustrating a method of measuring a mast lift height using the rotary encoder of FIG. 4.

### DETAILED DESCRIPTION OF THE DRAWINGS

For the purposes of promoting an understanding of the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

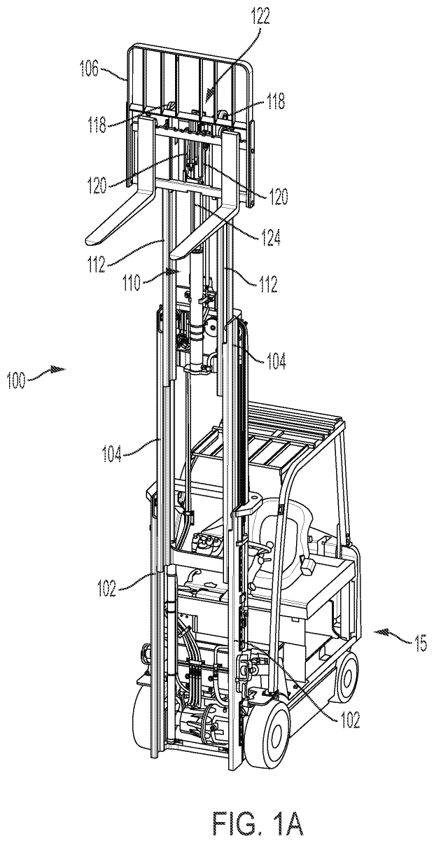

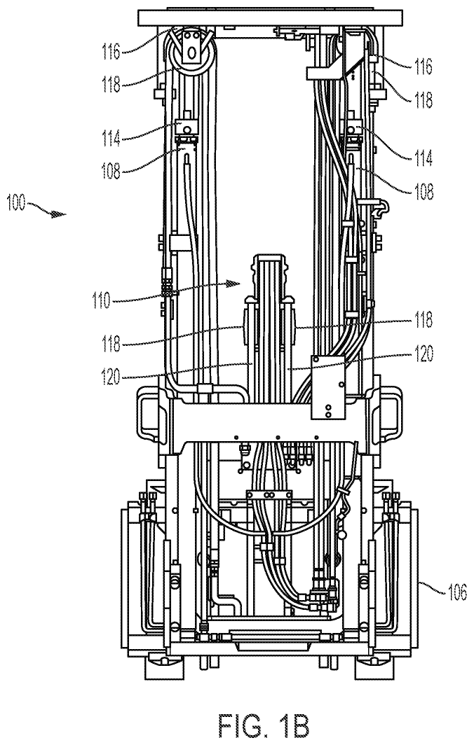

Referring initially to FIGS. 1A-1B, an exemplary three stage mast 100 is shown to illustrate operation of a longitudinally displaceable mast of a vehicle 15. The three stage mast 100 includes three linear actuators, including two rear lift cylinders 108 and a front lift cylinder 110 positioned therebetween, wherein each of the rear lift cylinders 108 and the front lift cylinder 110 is a hydraulic lift cylinder in an exemplary embodiment. Each of the rear lift cylinders 108 is coupled to an outer mast 102 and is configured to operationally lift a middle mast 104 positioned inward and adjacent to each outer mast 102 and an inner mast 112 positioned inward and adjacent to each middle mast 104. The piston head 114 of each rear lift cylinder 108 is coupled to the corresponding middle mast 104. Each outer mast 102 includes a rear lifting tether 116, such as a lifting chain, which is secured at a first end to the corresponding outer mast 102, passed over a corresponding pulley 118 coupled to the corresponding middle mast 104, and secured at a second end to the corresponding inner mast 112.

A carrier 106, for example, a fork of a forklift, is coupled to the front lift cylinder 110 so that the carrier 106 moves with operation of the three stage mast 100 as described further herein. The front lift cylinder 110 is mounted to the inner masts 112 so that movement of the inner masts 112 additionally move the front lift cylinder 110 as described further herein. Two front lifting tethers 120, such as lifting chains, are each secured at a first end to one of the corresponding inner masts 112, passed over a corresponding pulley 118 coupled to a top of a piston head 122 of the front lift cylinder 110, and secured at a second end to the carrier 106. As the front lift cylinder 110 operates, or during first stage operation, a piston rod 124 raises from the front lift cylinder 110, lifting the piston head 122 and, thereby, lifting the pulley 118, which actuates the front lifting tethers 120 in a manner that causes the tension between the carrier 106 and the pulley 118 to increase and the tether length between the carrier 106 and the pulley 118 to shorten, while the tether length between the pulley 118 and the inner mast 112 elongates, resulting in linear actuation of the carrier 106. The connections of the front lifting tethers 120 cause the carrier 106 to move upward at a pace that is twice the stroke of the front lift cylinder 110. Actuation of the front lifting tethers 120 additionally causes rotation of the corresponding pulleys 118.

Similarly, as the rear lift cylinders 108 operate, or during the second and third stages, a corresponding piston rod (housed within the rear lift cylinder 108 of FIG. 1B) raises from each of the rear lift cylinders 108, lifting the corresponding piston head 114 and directly raising the corresponding middle mast 104, and, thereby, lifting the corresponding pulley 118, which additionally actuates the corresponding rear lifting tether 116 in a manner that causes the tension between the pulley 118 and the inner mast 112 to increase and the length of the tether between the pulley 118 and the inner mast 112 to shorten, while the length of the tether between the pulley 118 and the outer mast 102 correspondingly lengthens, resulting in linear actuation of the inner mast 112. The connections of the rear lifting tethers 116 cause the inner masts 112 to move upward at a pace that is twice the stroke of the rear lift cylinders 108, which is also twice that of the middle masts 104. Actuation of the rear lifting tethers 116 additionally causes rotation of the corresponding pulleys 118.

Although the exemplification above is discussed in terms of three stage mast vehicles, other vehicles may utilize the system and method described herein as will be evidenced below, and the three stage mast vehicle discussed above is to be considered for exemplary purposes only. For example, the method and system as further described may also be utilized in vehicles having single stage masts, two stage masts, and quad masts, for example.

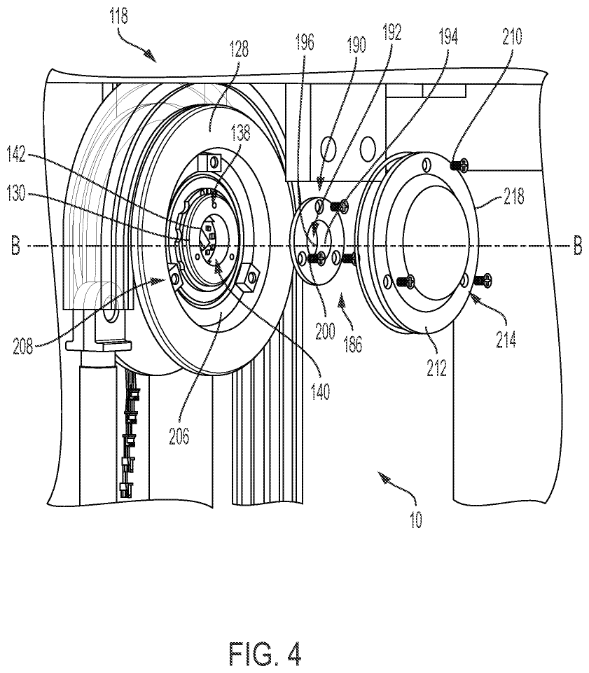

Now referring briefly to FIG. 4, each pulley 118 includes a sheave 128 for supporting the corresponding front lifting tethers 120 or rear lifting tethers 116, which also rotates with actuation of the corresponding lifting tethers 116, 120 (FIG. 1B) as described above. The sheave 128 is mounted to a pulley mounting boss 130, around which the sheave 128 rotates while the pulley mounting boss 130 remains relatively stationary.

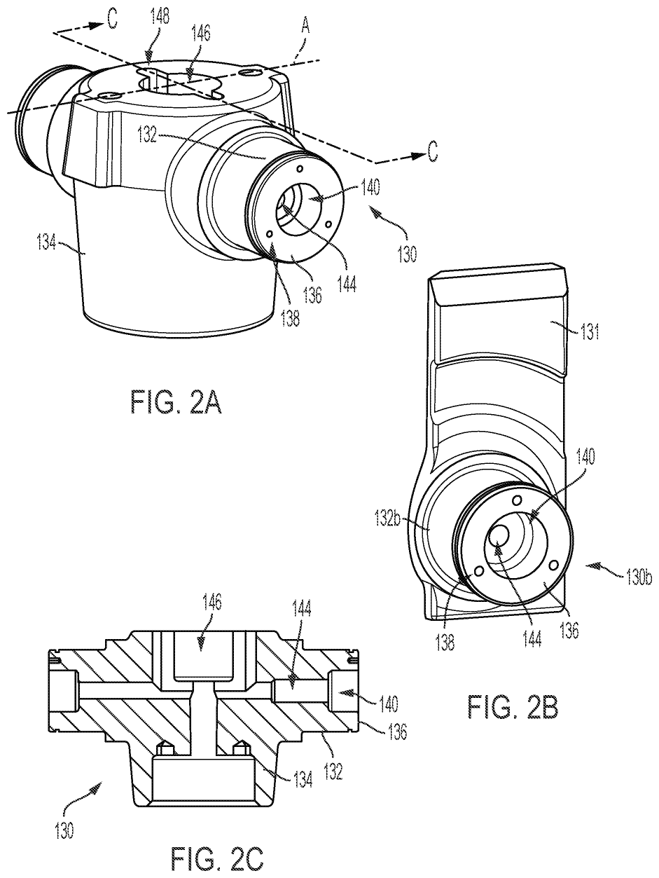

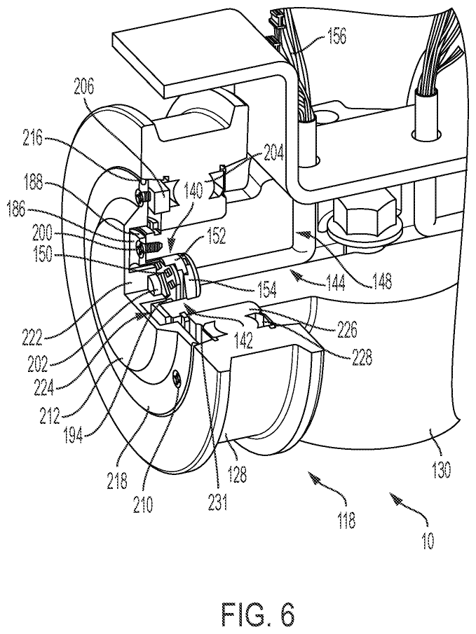

The pulley mounting boss 130 is further illustrated in FIGS. 2A-2C. The pulley mounting boss 130 includes a pulley arm 132 extending laterally from a center body 134 for mounting the sheave 128 (FIG. 4) so that the sheave 128 can rotate about the pulley arm 132. In particular, the exemplary pulley mounting boss 130 as illustrated in FIG. 2A is configured for operatively coupling with the front lift cylinder 110 (FIGS. 1A-1B) and therefore includes two pulley arms 132, each configured to receive a pulley 118 and corresponding sheave 128 (FIG. 4), so that each pulley arm 132 may include a rotary encoder 10 (FIG. 6) as described further herein. In an embodiment including two pulley arms 132, the mounting boss 130 may be symmetrical so that each half of the mounting boss 130 as defined by bisection “A” is substantially the same. In other embodiments, as shown in FIG. 2B, including configurations for rear lift cylinders or other mast configurations, the mounting boss 130b may include a single pulley arm 132b extending laterally from the center body 134b, wherein the characteristics of the pulley arms 132, 132b are substantially the same as described further herein.

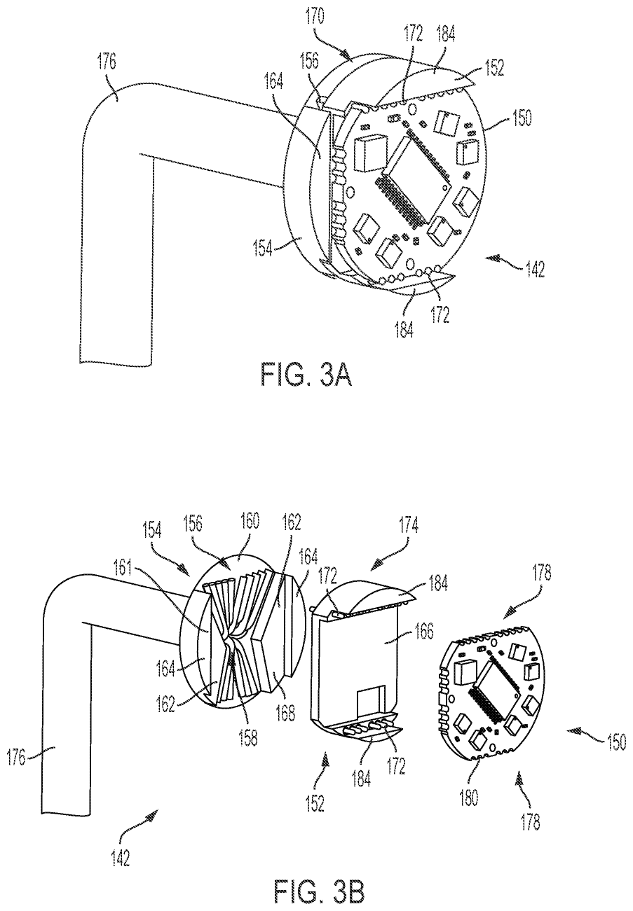

The pulley arm 132 has an end face 136 defining a plurality of apertures 138 configured to receive fasteners as discussed further herein. The pulley arm 132 further defines a bore 140 configured to receive a circuit board assembly 142 (FIG. 3A) as described further herein. A through hole 144 extends beyond the bore 140 further into the mounting boss 130 to receive wiring from the circuit board assembly 142 (FIG. 3A) to allow electric connection of the circuit board assembly 142 (FIG. 3A) to the vehicle 15 (FIG. 1A). A longitudinal bore 146 of the pulley mounting boss 130 facilitates attachment of the mounting boss 130 to the vehicle 15. For example, in the exemplary two-arm mounting boss 130, the longitudinal bore 146 may receive the piston head 122 of the front lift cylinder 110 and be secured to the piston head 122 with a fastener 121 (FIG. 6), or may otherwise facilitate mounting of the mounting boss 130 to the front lift cylinder 110. In embodiments including a single arm, such as a mounting boss 130 configured for use with a rear lift cylinder, the mounting boss 130 may include a longitudinal bore 146 within the body 134 of the mounting boss 130 to facilitate mounting of the mounting boss 130 to the rear lift cylinder, or may otherwise be mounted using conventional techniques, such as using a mounting plate 131. In embodiments including a longitudinal bore 146, the longitudinal bore 146 may further include at least one cut-out 148 to further facilitate passage of wiring.

Referring to FIGS. 3A-3B, the circuit board assembly 142 is illustrated. The exemplary circuit board assembly 142 includes a printed circuit board 150, an electrical insulator 152, and a flexible wire guide 154. Wires 156 are positioned through a through hole 158 of the flexible wire guide 154 and then positioned for electrical connection to the printed circuit board 150 as described further herein. The wires 156 are fanned against a backboard 160 of the flexible wire guide 154 between opposing stages 162, which extend radially inward from positioning ledges 164 arranged on two opposing edges of the backboard 160 and axially from the backboard 160 at a depth less than the depth defined between the backboard 160 and a top surface 161 of the positioning ledges. In an exemplary embodiment, the flexible wire guide 154 is formed of a flexible material, such as a thermoplastic polyurethane. The flexible material of the flexible wire guide 154 allows for variation in wiring for varying needs, as well as allows the flexible wire guide 154 to withstand a compressive load to facilitate stable positioning of the circuit board assembly 142 in a stationary position relative to the mounting boss 130, which may further be facilitated by friction existing between the flexible wire guide 154 and the mounting boss 130.

The non-conductive electrical insulator 152 is received by the flexible wire guide 154 so that a base 166 of the insulator 152 is adjacent to a top surface 168 of each of the stages 162 and positioned between positioning ledges 164. The placement of the insulator 152 creates a gap 170 between the base 166 of the insulator 152 and the backboard 160 of the flexible wire guide 154 to facilitate passage of the wires 156 for electrical connection to the circuit board 150 as described further herein. The insulator 152 includes a plurality of pins 172 to facilitate connection of the wires 156 to the circuit board 150 and protective ledges 184 extending from the base 166 of the insulator to cover the pins 172. A wire 156 is electrically coupled to a corresponding pin 172, such as by soldering the wire 156 to the pin 172 on the wire-guide-facing side 174 of the insulator 152. Each wire may be covered in heat shrink to protect the wiring after the electrical coupling is complete. After passing through the through hole 158 of the flexible wire guide 154 in a direction opposite of the insulator 152, the wires 156 are bundled within a cable 176, which is sized and shaped to fit through the through hole 144 of the pulley mounting boss 130 (FIGS. 2A-2C).

As illustrated, an exemplary insulator 152 may include 16 pins, 10 upper pins and 6 lower pins, although an alternative number of pins may be utilized as necessary. In some embodiments, the insulator 152 may not include any pins 172 as discussed further herein. In the exemplary embodiment illustrated having 16 pins 172, the wiring may be 26 AWG wiring, 28 AWG wiring, or a combination thereof. Five 1 mm pitch electrical connectors may be used for the 16 I/O signals to facilitate fit of the cable 176 within the through hole 144 of the pulley mounting boss 130 (FIGS. 2A-2C). Any electrical connectors used may be connected to a conversion board to ensure compatibility with an electrical system of the vehicle 15 (FIG. 1A). In other embodiments, an alternative number of pins, alternative sizing of wiring, numbering and sizing of electrical connectors, or alternative sizing of the through hole of the pulley mounting boss may be utilized as required or desired. For example, in other embodiments, the wiring 156 may be eliminated, wherein the circuit board 150 communicates with the vehicle and systems as described herein via wireless communication and inductive power generation.

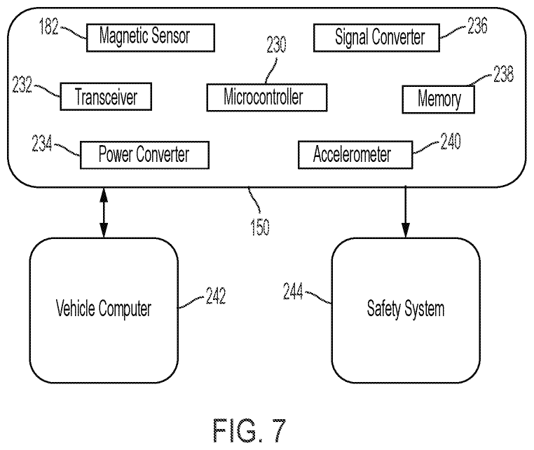

Still referring to FIGS. 3A-3B, the printed circuit board 150 has castellated edges 178 comprised of castellated holes 180 as input and output ports for the printed circuit board 150. The pins 172 of the insulator 152 each correspond to a castellated hole 180 of the circuit board 150 so that each pin 172 is received by a castellated hole 180 to connect the corresponding wire 156 with the circuit board 150. In an exemplary embodiment, the castellated edges 178 may be at least partially plated. The pins 172 may be soldered to the corresponding castellated hole 180 to facilitate connection between the pin 172 and the circuit board 150. The circuit board 150 further includes a magnetic sensor 182 (FIG. 7), which may be a Hall sensor in an exemplary embodiment. An exemplary circuit board 150 may include a single magnetic sensor, although other embodiments may include a plurality of magnetic sensors.

As discussed above, in another embodiment, the insulator 152 may not include the pins 172 to facilitate connection between the wiring 156 and the circuit board 150. In such an embodiment, the wires 156 may be soldered directly to the corresponding castellated holes 180 of the circuit board 150. In other embodiments, the wires 156 may be soldered directly to a circuit board 150 without castellated edges 178. In yet other embodiments, the circuit board assembly 142 may not include a flexible wire guide 154. In such an embodiment, the circuit board 150 may be potted within the mounting boss 130, wherein the wires 156 may be connected via the pins 172 within the insulator 152 or directly soldered to the circuit board 150 as discussed above. In an embodiment wherein the circuit board assembly 142 does not include a flexible wire guide 154, the wiring 156 may be bundled on a rear side of the circuit board 150 to be positioned through the mounting boss 130 as described above.

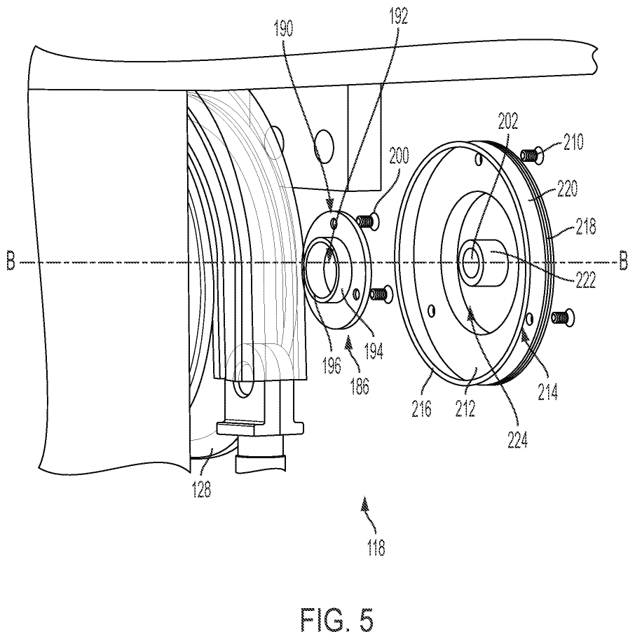

Referring again to FIG. 4, and additionally to FIGS. 5 and 6, the bore 140 of the pulley mounting boss 130 is deep enough to receive the circuit board assembly 142 and also partially receive a retaining ring 186. The retaining ring 186 includes a flange 188 defining a plurality of mounting apertures 190 and a center hole 192. A spacer 194 extends around a circumference of the center hole 192 and is configured to be received by the bore 140 of the pulley mounting boss 130 so that an edge 196 of the spacer 194 is positioned adjacent to a top face 198 of each protective ledge 184 of the insulator 152 (FIG. 3B). In some embodiments, the spacer 194 may extend around only a portion of the circumference of the center hole 192. A fastener 200 is received by each mounting aperture 190 of the retaining ring 186 and apertures 138 of the pulley mounting boss 130 to couple the retaining ring 186 to the mounting boss 130. The retaining ring 186 facilitates securing of the circuit board assembly 142 within the bore 140 of the pulley mounting boss 130 and the spacer 194 further facilitates proper spacing of the magnetic sensor 182 (FIG. 7) from a readable component, such as a permanent magnet 202 (FIGS. 5 and 6) as discussed further herein.

The exemplary pulley 118 illustrated in FIG. 4 is a ball bearing, wherein the sheave 128 is an outer ring of the bearing surrounding the underlying balls 204 (FIG. 6). A seal 206 is coupled to the sheave 128 so that the balls 204 (FIG. 6) are not exposed to facilitate smooth operation of the pulley 118. The seal 206 is coupled to the sheave 128 so that the seal 206 rotates with the sheave 128 during operation of the pulley 118. The seal 206 defines a plurality of apertures 208 configured to receive fasteners 210 as further described herein. An exemplification of seal 206 is formed at least in part of rubber to facilitate the sealing characteristic of the seal component 206. In other embodiments, the seal 206 may be formed at least in part of polytetrafluoroethylene or polyacrylate elastomer. A cover 212 defining apertures 214 around a perimeter of the cover is configured to couple to the seal 206 via fasteners 210, apertures 214 of the cover 212, and apertures 208 of the seal 206 so that the cover 212 rotates with the seal 206 and the sheave 128. A dust seal, such as O-ring 216, may be positioned around the perimeter edge 218 of the cover 212 to create a seal between the cover 212 and the sheave 128 to prevent debris from entering the space therebetween.

Referring now to FIG. 5, a back face 220 of the cover 212 defines a magnet holder 222 for receiving the magnet 202. The back face 220 of the cover 212 may further define a trough 224 surrounding the magnet holder 222 to facilitate proper spacing of the magnet 202 from the magnetic sensor 182 (FIG. 7) while allowing for proper attachment of the cover 212 to the pulley 118. As mentioned above, in an exemplary embodiment, the magnet 202 is a permanent magnet having at least two opposing poles. The magnet 202 is held within the magnet holder 222 of the cover 212 so that the magnet 202 rotates as the cover 212 rotates with the pulley 118. The magnet holder 222 is positioned on the cover 212 so that as the cover rotates with the pulley 118, the magnet 202 rotates about an axis “B”, which is an axis common with bore 140 of the mounting boss 130 (see also FIG. 4). In other embodiments, the magnet 202 may be mounted within the bore 140 of the mounting boss 130, while the magnetic sensor 182 (FIG. 7) is mounted to the sheave 128 of the pulley 118, wherein the wiring 156 is positioned through a slip ring to couple the magnetic sensor 182 (FIG. 7) to the vehicle 15 rather than positioning the wiring 156 through the mounting boss 130 as described herein. In yet other embodiments, the magnet 202 may alternatively be replaced with another readable component, such as an optically read pattern, wherein the magnetic sensor 182 (FIG. 7) is replaced with another sensor, such as an optical rotary sensor.

FIG. 6 provides a cross-sectional view of an assembled rotary encoder 10 including the components described above. As shown, when assembled, the balls 204 of the ball bearing pulley 118 are positioned between the sheave 128 and an inner bearing race 226. The seal 206 is positioned between the sheave 128 and the inner bearing race 226 so that the balls 204 are covered on a first side of the pulley 118 and the seal 206 rotates with the sheave 128, while a cover plate 228 covers the balls 204 laterally on a second side of the pulley 118. The cover 212 is fastened to the seal 206 via fasteners 210 so that the cover 212 rotates with the sheave 128, and the perimeter edge 218 of the cover is received within an inner circumference 231 defined by the sheave 128 with a dust seal 216 positioned therebetween.

The pulley 118 is mounted on the pulley mounting boss 130 so that the pulley 118 can rotate about the pulley mounting boss 130, which remains stationary. The circuit board assembly 142 is housed within the bore 140 of the stationary pulley mounting boss 130, including the circuit board 150, the insulator 152, and the flexible wire guide 154 as described above. As the wires 156 extend away from the circuit board assembly 142, they are bundled within the cable 176, which is fed through the through hole 144 and the cut-out 148 of the mounting boss 130 to connect to the electrical system of the vehicle 15 (FIG. 1A).

The spacer 194 of the retaining ring 186 is received within the bore 140 of the mounting boss 130 so that the edge 196 of the spacer 194 is adjacent to the circuit board assembly 142 to help maintain the position of the circuit board assembly 142 within the bore 140 and maintain proper distance between the circuit board assembly 142 and the magnet 202. The flange 188 of the retaining ring 186 is fastened to the stationary pulley mounting boss 130 via fasteners 200 to maintain the position of the retaining ring 186, including the spacer 194.

The magnet holder 222 containing magnet 202 is at least partially received within the bore 140. The trough 224 of the cover 212 may receive a portion of the retaining ring 186 and the mounting boss 130 to facilitate proper positioning of the magnet holder 222 and magnet 202 relative to the circuit board assembly 142 while also allowing coupling of the cover 212 to the seal 206 via fasteners 210 as described above. The assembly of the rotary encoder 10 results in maintenance of proper spacing between the magnetic sensor 182 (FIG. 7) and the magnet 202 to facilitate accurate and precise measurement. In an exemplary embodiment, a distance between the magnet 202 and the magnetic sensor 182 (FIG. 7) may measure about 2 mm. In other embodiments, the distance between the magnet and the magnetic sensor may measure about 1 mm, about 3 mm, about 4 mm, about 5 mm, about 6 mm, or another distance according to the requirements of the magnetic sensor. In an alternative embodiment, the center hole 192 of the retaining ring 186 may contain a clear coating, such as epoxy resin, to further protect the circuit board 150 while allowing communication between the magnet 202 and the magnetic sensor 182 (FIG. 7).

As shown by schematic circuit board 150 in FIG. 7, the circuit board 150 may include all or some combination of the magnetic sensor 182, a microcontroller 230, a transceiver 232, a power converter 234, a signal converter 236, a memory 238, and an accelerometer 240. The circuit board 150 is communicatively coupled with a vehicle computer 242 accessible by a user of the vehicle 15 (FIG. 1A), for example, via a user interface, and a safety system 244 of the vehicle 15. The vehicle computer 242 may communicate with the microcontroller 230 using two-way communication so that a user may use the vehicle computer 242 to request a status of the mast via the rotary encoder 10 (FIG. 6). In other embodiments, the vehicle computer 242 may request the status of the mast automatically according to predetermined settings without intermediate user intervention. In an embodiment including two-way communication, the vehicle computer 242 may communicate using controller area network (“CAN”) bus signals. The CAN bus signals may first be received by the transceiver 232 to convert the CAN bus signals to TX and/or RX signals to be processed by the microcontroller 230. Similarly, the microcontroller 230 may communicate with the vehicle computer 242 via the transceiver 232, which converts TX and/or RX signals to CAN bus signals to be processed by the vehicle computer 242. In an exemplary embodiment, the microcontroller 230 may be a 16-bit microcontroller, and in some embodiments may be Part Number dsPIC33EV256GM102 manufactured by Microchip Technology, Inc. (Chandler, Ariz.). The transceiver 232 may be a CAN transceiver, and in some embodiments may be Part Number MCP2561 manufactured by Microchip Technology, Inc. (Chandler, Ariz.).

The power converter 234 converts truck accessory bus voltage received by the wiring 156 (FIG. 3B) to a voltage compatible with the circuit board components described herein. For example, in an exemplary embodiment, the power converter 234 performs a power conversion from 3-30 volts to 5 volts or, for example, from 36-48 volts to 5 volts. In another exemplary embodiment, the converter 234 may perform a power conversion from 3-48 volts to 3.3 volts. In other embodiments, the power converter 234 operates to convert the truck accessory bus voltage to a voltage otherwise required by the circuit board components. In some embodiments, the power converter 234 may be Part Number MIC5239-5.0YMM manufactured by Microchip Technology, Inc. (Chandler, Ariz.). The memory 238 may be a random access memory to facilitate operation of the rotary encoder 10 (FIG. 6). The memory 238 may additionally or alternatively include a nonvolatile memory so that if a power loss occurs or the vehicle is otherwise powered off, the last-stored readings from the memory 238 pertaining to angular position, as described further herein, are loaded upon power up to ensure stable position readings between power cycles. In some embodiments, the memory 238 may be Part Number 47C16 manufactured by Microchip Technology, Inc. (Chandler, Ariz.).

The accelerometer 240 may be a 2-axis accelerometer. In some embodiments, the accelerometer 240 may be Part Number MXC6244AU manufactured by MEMSIC Semiconducter Co., Ltd. (China). The accelerometer 240 may be configured to detect impulse force events and cooperate with the microcontroller 230 to predict and warn against collisions. For example, the microcontroller 230 may read and store within the memory 238 measured accelerations transmitted by the accelerometer 240 and received by the microcontroller 230. The microcontroller 230 may further compare the measured accelerations to a predetermined acceleration threshold and transmit an impact warning to the vehicle computer 242 as described above in the event a measured acceleration meets or bypasses the predetermined acceleration threshold. The predetermined acceleration threshold may be set and/or modified by the user or may otherwise be preprogrammed as a default acceleration threshold or a permanent acceleration threshold as appropriate. The user may customize the encoder output message via the vehicle computer 242 to include or not include the accelerometer reading.

In an exemplary embodiment, the magnetic sensor 182 is a Hall sensor, and in some embodiments may be Part Number A1339LLPTR-DD-T-ND manufactured by Allegro MicroSystems (Bulgaria). The magnetic sensor 182 reads and processes the angular change of the magnet 202 (FIGS. 5-6) as the magnet 202 rotates using two electrically separate measurement dies, which allows each of the measurement dies to be operational independent of the other. In particular, the magnet sensor 182 measures the passage of the opposing poles of the magnet 202 (FIGS. 5-6) as the magnet 202 rotates as described above. Each measurement die can output a first signal, which may comprise a serial peripheral interface (“SPI”) signal or a pulse-width modulation (“PWM”) signal, simultaneous with a second signal, which may comprise an absolute quadrature signal. Generated first signals are sent to the microcontroller 230 to be processed. In an exemplary embodiment, the microcontroller 230 constantly reads both SPI buses connected to each die of the magnetic sensor 180 to obtain the angular position from both dies. Readings from each measurement die on the magnetic sensor 182 may be repeatedly compared by the microcontroller 230 to ensure the readings are within a predetermined redundancy threshold to facilitate accurate measurements. The readings are then stored in the memory 238 by the microcontroller 230. The microcontroller 230 then communicates the processed information to the vehicle computer 242 as described above. In particular, the microcontroller 230 may combine and transmit the readings to the vehicle computer 242 at predetermined intervals or upon receiving a request for information received from the vehicle computer 242 as described above. The encoder 10 (FIG. 6) may be configured by the user via the vehicle computer 242 to output the angular position in degrees or radians and number of turns or the lift height of the mast in varying units when a pulley diameter and mast type is provided.

The second signal is automatically output and is not processed by the microcontroller 230. In an exemplary embodiment, the second signal may instead be output directly from the magnetic sensor 182 to the safety system 244. In some embodiments, the absolute quadrature signal may be output directly from the magnetic sensor 182 to the signal converter 236. In some embodiments, the signal converter may be Part Number MAX13486EELA+T manufactured by Maxim Integrated (San Jose, Calif.). The signal converter 236 converts each absolute quadrature signal into a differential quadrature signal, which allows for the quadrature encoder reading to reliably transmit over longer cabling when necessary. For example, per transmission in an exemplary embodiment, the signal converter 236 may be configured to convert three absolute quadrature signals from each die into six differential signals for each die. In such an exemplary embodiment, after conversion, the differential quadrature signal is transmitted to the safety system 244. In either embodiment, the safety system 244 is configured to take direct input of either the absolute quadrature signal or the differential quadrature signal as appropriate. In an exemplary embodiment, the signal converter 236 may be communicatively coupled to the microcontroller 230 via a logic high signal, so that the microcontroller is capable of disabling the output to the safety system 244 by drawing the logic high line low with a pull down resistor in the event a reading is determined by the microcontroller 230 to be faulty. Because transmission of the quadrature signals is automatic, malfunction of the microcontroller 230, magnetic sensor 182, or signal converter 236 may stop the transmission of the signals to the safety system 244, causing the vehicle 15 to enter a fault state. A predicted collision or other detected safety concern discerned from the signal received by the safety system may also cause the vehicle 15 (FIG. 1A) to enter a fault state. The user may enable or disable the quadrature output for the safety system 244 via the vehicle computer 242 without interrupting the other functionalities of the encoder 10 (FIG. 6).

The magnetic sensor 182 may also measure magnetic field strength generated by the magnet 202 (FIGS. 5-6) and/or temperature of the rotary encoder 10 (FIG. 6). In other embodiments, the temperature of the rotary encoder 10 may be monitored by an independent temperature sensor communicatively coupled to the microcontroller 230. Extreme temperatures may result in an encoder error state. Additionally, a failed magnetic field reading may indicate physical damage has occurred to the magnetic sensor 182 or another component of the encoder 10 (FIG. 6), which may result in an encoder error state. The user may customize the encoder output message to include or not include the temperature reading, the magnetic field reading, or a combination thereof via the vehicle computer 242.

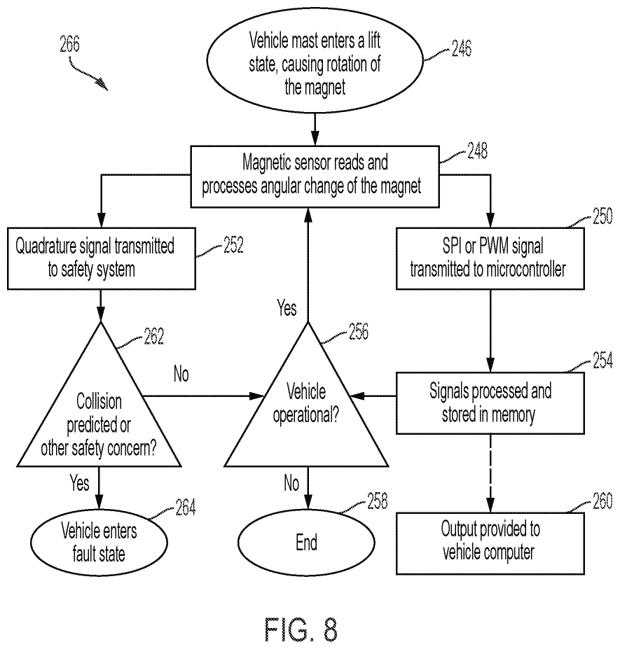

Now referring to FIG. 8, a method 266 of measuring the height of the lift mast using the rotary encoder 10 (FIG. 6) is provided. At step 246, the vehicle mast enters a lift state, causing rotation of the magnet as described above. As the magnet rotates, the magnetic sensor reads and processes the angular change of the magnet at step 248 using two electrically separate measurement dies. Each die simultaneously transmits a first signal to the microcontroller at step 250 and transmits a second signal to the safety system of the vehicle at step 252.

The microcontroller processes the first signal received from the magnetic sensor and stores the processed signal in the memory at step 254. In an exemplary embodiment, the memory is a non-volatile memory that facilitates the loading and access of stored signals between power cycles. The memory may also compare the signals received from each measurement die to ensure the readings are within a predetermined redundancy threshold. If the vehicle is operational at step 256, the magnetic sensor continues to read and process the angular change of the magnet at step 248 and transmit additional signals to the microcontroller at step 250 to continue the method. If the vehicle is not operational at step 256, the method ends at step 258. The microcontroller may also provide the output of the first signal received from the magnetic sensor to the vehicle computer at step 260. This may occur at predetermined time intervals and/or may occur when the microcontroller receives a request from the vehicle computer. Communication between the microcontroller and the vehicle computer may include sending signals via the transceiver, which is configured to convert CAN bus signals used by the vehicle computer to RX and/or TX signals used by the microcontroller and convert RX and/or TX signals to CAN bus signals as appropriate for facilitating communication.

At step 252, the magnetic sensor may transmit a second signal to the safety system or to the signal converter. The signal converter may convert the second signal, for example an absolute quadrature signal, to a differential quadrature signal to reliably transmit the signal over the distance between the encoder and the safety system. After conversion of the signal, the differential quadrature signal is transmitted to the safety system. If the output of the magnetic sensor indicates that a collision is predicted or there may be another safety concern at step 262, the vehicle enters a fault state at step 264, ending the method. If the output of the magnetic sensor does not indicate that there is a safety concern at step 262 and the vehicle is operational at step 256, the magnetic sensor continues to read and process the angular change of the magnet at step 248 and transmit additional signals to the safety system of the vehicle at step 252. If the vehicle is not operational at step 256, the method ends at step 258.

Although the exemplification above is discussed in terms of a pulley system of a vehicle mast, the components and arrangement thereof as described may apply to other rotary components within the lift system of the vehicle, and the pulley system discussed above is to be considered for exemplary purposes only. For example, the encoder may be mounted on and utilized in relation to lifting tether pulleys, hose pulleys, or mast rollers between mast stages.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A forklift, comprising:
a carrier having a variable lift height;
an actuator operable to lift the carrier; and
a sensor integrated into the actuator and operable to provide a signal indicative of a position of the carrier along the carrier lift height.

2. The forklift of claim 1, wherein the actuator comprises:
a linear actuator;
a tether secured to a first component and a second component; and
a pulley rotatably supported on the linear actuator, the tether positioned over the pulley intermediate the first component and the second component, whereby actuation of the linear actuator actuates the tether and rotates the pulley.

3. The forklift of claim 2, wherein the linear actuator comprises a hydraulic cylinder and a hydraulic piston, the tether secured to the piston.

4. The forklift of claim 2, wherein the pulley comprises a sheave, the tether positioned in the sheave whereby actuation of the tether by the linear actuator rotates the sheave, and wherein the sensor comprises a magnet secured for rotation with the sheave.

5. The forklift of claim 4, wherein the actuator further comprises a mounting boss, the sheave of the pulley rotatably supported on the mounting boss, and wherein the sensor further comprises a magnetic sensor housed by the mounting boss and positioned to sense the angular position of the magnet.

6. The forklift of claim 2, wherein the tether is a lift chain.

7. The forklift of claim 2, wherein the first component is the carrier and the second component is an inner mast.

8. The forklift of claim 2, wherein the first component is an inner mast and the second component is an outer mast.

9. A rotary encoder for measuring a lift height of a vehicle, comprising:
a mounting boss comprising an arm defining a bore;
a sheave mounted on the arm of the mounting boss and configured to rotate about the arm;
a circuit board assembly positioned within the bore of the mounting boss, the circuit board comprising a magnetic sensor; and
a cover coupled to the sheave and configured to rotate with the sheave, wherein a back face of the cover defines a magnet holder containing a magnet so that the magnet rotates upon actuation of the sheave.

10. The rotary encoder of claim 9, wherein the mounting boss further comprises a through hole extending beyond the bore into the mounting boss to carry wiring between the circuit board assembly and an electrical system of the vehicle.

11. The rotary encoder of claim 9, wherein the cover is attached directly to a seal coupled to the sheave and configured to rotate with the sheave.

12. The rotary encoder of claim 11, wherein the sheave is a ball bearing and the seal covers a plurality of balls.

13. The rotary encoder of claim 9, further comprising a retaining ring having a spacer at least partially received within the bore of the mounting boss so that an edge of the spacer is adjacent to the circuit board assembly and a flange of the retaining ring is coupled to an end face of the arm of the mounting boss.

14. The rotary encoder of claim 13, wherein the cover defines a trough surrounding the magnet holder so that at least a portion of the flange of the retaining ring is received within the trough and at least a portion of the magnet holder is received within the bore.

15. The rotary encoder of claim 9, wherein the circuit board assembly is comprised of a wire guide, an insulator, and a circuit board.

16. (canceled)

17. The rotary encoder of claim 15, wherein the wire guide comprises a backboard defining a through hole configured to receive wiring, positioning ledges arranged on two opposing edges of the backboard, and a stage extending laterally from each of the positioning ledges.

18. The rotary encoder of claim 17, wherein the insulator is received between the positioning ledges of the wire guide so that a base of the insulator is adjacent to a top surface of each stage and a gap is defined between the base of the insulator and the backboard of the wire guide.

19. The rotary encoder of claim 15, wherein the circuit board comprises castelled edges for receiving a plurality of pins of the insulator.

20. A system for measuring a lift height of a vehicle, the system comprising:
a rotary encoder comprising:
a mounting boss comprising an arm defining a bore;
a sheave mounted on the arm of the mounting boss and configured to rotate about the arm;
a circuit board assembly positioned within the bore of the mounting boss,
the circuit board comprising a magnetic sensor; and
a cover coupled to the sheave and configured to rotate with the sheave,
wherein the cover defines a magnet holder containing a magnet so that the magnet rotates upon actuation of the sheave;
wherein the circuit board assembly configured to measure the lift height of the vehicle using the magnetic sensor in relation to rotation of the magnet;
a safety system of the vehicle in communication with the circuit board assembly; and
a vehicle computer;
wherein the circuit board assembly is configured to simultaneously transmit lift height information to the safety system of the vehicle and the vehicle computer.

21. The system of claim 20, wherein the magnetic sensor includes two measurement dies, each of the measurement dies configured to output a first signal to a microcontroller of the circuit board assembly and a second signal to the safety system of the vehicle simultaneously.

22. (canceled)

23. (canceled)

24. (canceled)

25. (canceled)

26. The system of claim 20, wherein the vehicle computer and the circuit board assembly are communicatively coupled with two-way communication.

27.-40. (canceled)
